(19) United States
(12) Patent Application Publication
(10) Pub. No.: US 2006/0212818 A1
(43) Pub. Date: Sep. 21, 2006

(54) Method for providing multimedia message

(76) Inventor: Doug-Heon Lee, Seoul (KR)

Correspondence Address: John M Janeway;Graybeal Jackson Haley, 155- 108th Ave NE, Suite 350, Bellevue, WA, 98004-5973, US

(21) Appl. No.: 10/566,854

(22) PCT Filed: Jul. 30, 2004
(86) PCT No.: PCT/KR04/01932

§ 371 Date: Jan. 31, 2006

(30) Foreign Application Priority Data
Jul. 31, 2003 (KR) 10-2003-0052993

(51) Int. Cl. H04N 5/44

(52) U.S. Cl. 715/753; 715/716; 345/629

(57) ABSTRACT

The invention relates to a method for providing multimedia messages to a receiver mobile terminal, which multimedia messages are generated out of an original text message sent by the service user. According to the present invention, the method for providing multimedia messages is advantageous in that, by providing a new multimedia message that is generated by combining user's original text message and the prepared multimedia data or the prepared text data, the mobile message service may enable various representations in messages, and further enables more enhanced type of business.

### TECHNICAL FIELD

The present invention relates, in general, to a method of converting an original text message into a multimedia message and providing the multimedia message to a recipient's terminal unit, in particular, to a mobile communication terminal, and a method of converting an original text message into a combination-type text message and providing the combination-type text message to the terminal unit.

More particularly, the present invention relates to the technology of combining prepared multimedia data or text data with a text message transmitted by a service user to create a new multimedia message or combination-type short message, and providing the multimedia message or combination-type short message to a recipient's terminal unit, thus providing various types of message services.

### BACKGROUND ART

Recently, with the increase in popularity of mobile terminal units, such as mobile phones, the use of a Short Message Service (SMS) using mobile terminal units has become popular. Such an SMS is typically provided to mobile terminal units, and widely used because service charges are low, and the reception speed and readability by a receiving party are high.

FIG. 1 is a view showing an example of a conventional short message service using a mobile terminal unit. According to the embodiment of FIG. 1, a message created by a service user is displayed on the display device of the terminal unit in the form of text. As shown in the drawing, a message used in a short message service includes a combination of characters called an “emoticon” in addition to characters. The combination of characters is used to sufficiently communicate various emotions of the user under a limited environment.

FIG. 2 is a view showing an example of a system for providing the conventional short message service. In FIG. 2, a service user 210 creates a text message 230 using the keypad on an originator's terminal unit 220, designates a recipient's terminal unit 250 using a typical phone number, and commands the terminal unit 220 to transmit the text message 230. The text message 230 transmitted from the originator's terminal unit 220 is received by a message center 240. The message center 240 transmits the text message 230 to the recipient's terminal unit 250 designated by the service user 210.

The conventional short message service has many restrictions in presentation because it currently provides only a text message due to the limitations of a wireless data communication rate and the input means of a mobile phone. In order to overcome the restrictions, a method using so-called emoticons, etc., as shown in FIG. 1, has been used, but is not sufficient.

In the present specification, the “message center 240” should be interpreted as a concept indicating an entire system that receives a request for a message transmission service from the originator's terminal unit 220, creates a message on the basis of the service contents thereof and provides the created message to the recipient's terminal unit 250. In order to increase the convenience of construction and the management efficiency of the message center, the message center 240 is, typically installed in the entire system of a mobile communication service provider.

Further, in the present specification, the “provision” of a message to the recipient's terminal unit 250 includes a case where the recipient's terminal unit 250 accesses the message center 240 to read a message, in addition to a case where the message center 240 transmits a message to the recipient's terminal unit 250. Moreover, the provision should be interpreted as a concept including a case where a message is transmitted from the message center 240 to the recipient's terminal unit 250 using a predetermined protocol, such as a typical HyperText Transfer Protocol (HTTP).

That is, if a message is transmitted from the message center 240 to the recipient's terminal unit 250 without being limited in detailed implementation schemes, this case corresponds to the “provision” of the present specification. Further, in the present specification, the “terminal unit” should be interpreted as a concept including a Personal Computer (PC), a Personal Digital Assistant (PDA), a set-top box, or a digital television (TV), in addition to the mobile terminal unit shown in FIG. 2. That is, the present invention also takes an embodiment, in which a text message 330 is created on a PC 320 and transmitted to a mobile terminal unit 350 as shown in FIG. 3, into consideration.

### DISCLOSURE OF THE INVENTION

Accordingly, an object of the present invention is to provide a method for providing multimedia messages or combination-type short messages, which creates a new multimedia message or combination-type short message by combining prepared multimedia data or text data with a text message transmitted by a service user, and provides the multimedia message or combination-type short message to a recipient's terminal unit, thus providing various types of message services.

### BRIEF DESCRIPTION OF THE DRAWINGS

FIG. 1 is a view showing an example of a conventional short message service;

FIG. 2 is a view showing an example of a system for providing the conventional short message service;

FIG. 3 is a view showing another example of a system for providing the conventional short message service;

FIG. 4 is a view showing a system for providing a multimedia message service according to an embodiment of the present invention;

FIG. 5 is a view showing a system for providing a multimedia message service according to another embodiment of the present invention;

FIG. 6 is a view showing a multimedia message service according to an embodiment of the present invention;

FIG. 7 is a view showing a multimedia message service according to another embodiment of the present invention;

FIG. 8 is a view showing a combination-type short message service according to an embodiment of the present invention;

FIG. 9 is a view showing combination-type short messages according to embodiments of the present invention; and

FIG. 10 is a view showing a server system for providing a multimedia message service and a combination-type short message service according to an embodiment of the present invention.

### BEST MODE FOR CARRYING OUT THE INVENTION

Hereinafter, embodiments of the present invention will be described in detail with reference to the attached drawings.

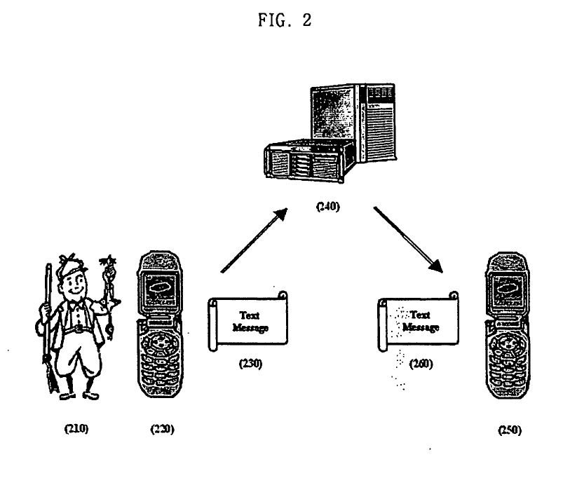

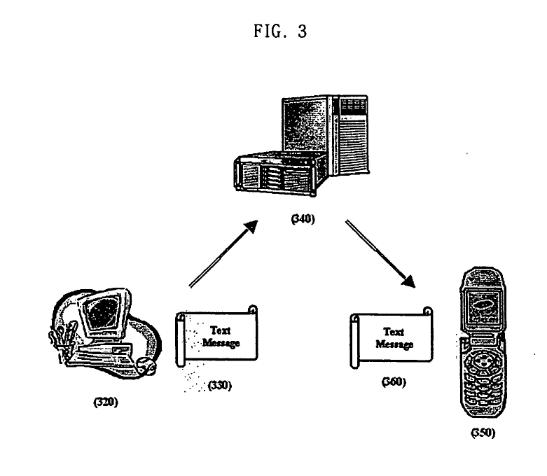

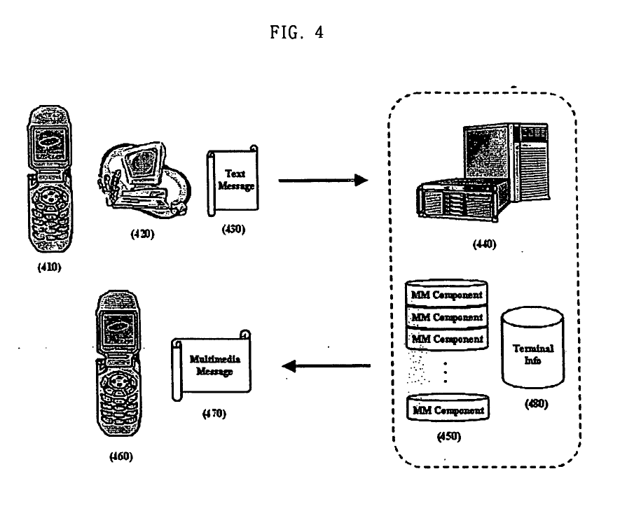

FIG. 4 is a view showing a system for providing a multimedia message service according to an embodiment of the present invention. As described above with reference to FIGS. 2 and 3, a service user creates a text message 430 using a mobile terminal unit 410 or a PC 420, designates a recipient's terminal unit 460 using a typical phone number, and commands the terminal unit or PC to transmit the text message 430. In FIG. 4, the text message 430 created by the service user is a text-type character message similar to a conventional message, which is required to be compatible with a conventional message service environment.

A message center 440 is similar to conventional message centers 240 and 340 in that it performs the basic function of conventional message centers 240 and 340, that is, a function of mediating message communication between an originator's terminal unit 410 or 420 and the recipient's terminal unit 460. However, the message center 440 of the present invention performs an operation of creating a multimedia message 470 to be transmitted to the recipient's terminal unit 460 on the basis of the text message 430 transmitted from the originator's terminal unit 410 or 420 in cooperation with a multimedia library unit 450 of the present invention, unlike the conventional message centers 240 and 340.

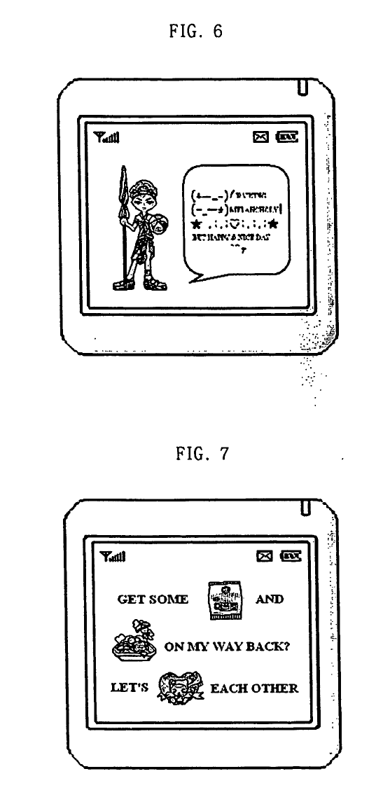

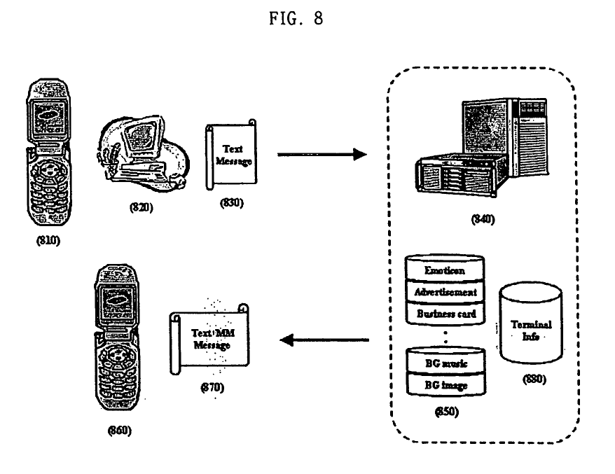

The above-described multimedia library unit 450 provides reference data to create the multimedia message 470 on the basis of the text message 430. As shown in the drawing, the multimedia library unit 450 is comprised of a plurality of multimedia sub-components. The multimedia sub-components may include various types of reference data, which will be described later after the description of FIGS. 6 and 7.

As shown in FIG. 4, the multimedia library unit 450 of the present invention is not necessarily implemented in the message center 440, but need only be implemented such that it can operate in cooperation with the message center 440. For example, even though the multimedia library unit 450 is constructed as a separate system, it is sufficient that the multimedia library unit 450 is connected to the message center 440 through a wired or wireless network, and then the message center 440 can refer to the data of the multimedia library unit 450 when desired. However, in order for the service system to operate more efficiently, it is preferable that the multimedia library unit 450 be implemented in the message center 440 as a kind of database file. Even in this case, in the present specification, the multimedia library unit 450 and the message center 440 are not integrally designated as the message center 440, but they are conceptually separate and described separately.

As described above, through the cooperation between the message center 440 and the multimedia library unit 450, the multimedia message 470 is created on the basis of the text message 430. As shown in the drawing, the multimedia message 470 created in this way is transmitted to the recipient's terminal unit 460, and suitably displayed on the recipient's terminal unit 460 in response to the manipulation of the service user.

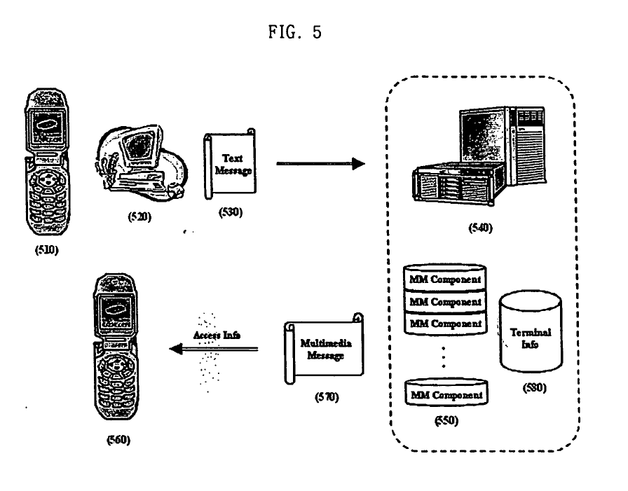

The construction and function of a terminal information database unit 480 shown in FIG. 4 are described together with the description of FIG. 5.

FIG. 5 is a view showing a system for providing a multimedia message service according to another embodiment of the present invention. The embodiment of FIG. 5 is similar to that of FIG. 4 in that a message center 540 creates a multimedia message 570 to be transmitted to a recipient's terminal unit 560 on the basis of a text message 530 transmitted from an originator's terminal unit 510 or 520 in cooperation with a multimedia library unit 550. However, this embodiment is different from that of FIG. 4 in that the message center 540 does not transmit the multimedia message 570 to the recipient's terminal unit 560, but places the multimedia message 570 at a predetermined location and provides access information to this location to the recipient's terminal unit 560 so that the recipient's terminal unit 560 accesses the location and is provided with the multimedia message 570.

This construction is required because some recipients terminal units 560 may not have the capability of receiving and processing the multimedia message 470 when the multimedia message 470 is transmitted, as shown in FIG. 4. For example, in an SMS service provided by a mobile communication service provider in Korea at the time of the initial application of this patent, the size of a message capable of being received by the recipient's terminal unit 560 from the message center 540 has an upper limit of 80 bytes, so that it is not possible to provide the service of FIG. 4 to a recipient's terminal unit 560 optimized for the above SMS service. In this case, as a kind of alternative plan, the multimedia message 570 is placed at a predetermined location, and the access information to the location is provided to the recipient's terminal unit 560 so that the recipient's terminal unit 560 accesses the location and is provided with the multimedia message 570, as shown in FIG. 5.

In this embodiment, a technique designated as a so-called callback Uniform Resource Locator (URL) may be beneficially used. According to this technique, the message center 540 places the created multimedia message 570 in a specific directory within a Web server connected to the Internet as a kind of multimedia resource, and provides a URL indicating the multimedia resource of the Web server to the recipient's terminal unit 560 as the above access information in the form of a text message.

Then, if the service user selects the callback URL message on his or her terminal unit 560, a browser in the recipient's terminal unit 560 is run, so that the recipient's terminal unit 560 accesses and is provided with the multimedia resource of the Web server according to the callback URL, and suitably displays the multimedia resource on a screen. During the process of accessing and being provided with the resource on the Web server by the browser of the terminal unit 560, since the above-described limitation of data size is not applicable, the callback URL technique can be a preferred method of implementing a service with respect to the recipient's terminal unit 560.

Further, although not shown in the drawing, if the recipient's terminal unit 460 or 560 is optimized for the conventional text message 430 or 530 and there is no capability of displaying the multimedia message 470 or 570 even though the multimedia message 470 or 570 is received, the message center 440 or 550 must transmit the text message 430 or 530 to the recipient's terminal unit 460 or 560 without change.

As described above, the capability of the terminal unit 460 or 560 may have a plurality of levels in relation to the multimedia message service of the present invention. In the present specification, a term “profile” is intended to be used to represent such capability levels. For example, if, in the above-described multimedia service environment, a terminal unit 460 capable of supporting the multimedia message service of FIG. 4, a terminal unit 560 capable of supporting only the multimedia message service of FIG. 5, and a terminal unit incapable of supporting the multimedia message services exist together, three types of terminal unit profiles exist in the service environment.

As described with reference to the embodiments of FIGS. 4 and 5, in the service environment where a plurality of profiles exists together, the message center 440 or 540 must learn the profile of the recipient's terminal unit 460 or 560 on the basis of the identifier of the recipient terminal unit, for example, the recipient's phone number, and determine whether the multimedia message 470 can be directly transmitted to the recipient's terminal unit 460 as shown in FIG. 4, or whether the multimedia message 570 should be placed at a predetermined location and the access information thereto should be transmitted to the recipient's terminal unit 560 as shown in FIG. 5.

Terminal information database units 480 and 580 of FIGS. 4 and 5 are provided for the above object, and operated in cooperation with the message centers 440 and 540 to provide information about profiles of corresponding terminal units according to the identifiers of the recipient's terminal units. For this operation, the terminal information database unit 480 or 580 is equipped with information about the capability of the terminal units in a kind of database, and provides information required to determine the profile of the corresponding terminal unit 460 or 560 in response to a terminal unit identifier if the message center 440 or 540 presents the terminal unit identifier.

In a service environment where the recipient's terminal unit 460 or 560 has a single capability in the multimedia message service according to the present invention, it is sufficient to provide the service using only one kind of method. In this case, the above-described determination of the capability of the recipient's terminal unit 460 or 560 is not necessary, so that the terminal information database units 480 and 580 of FIGS. 4 and 5 may not be necessary. Similar to the above description related to the multimedia library units 450 and 550, the terminal information database units 480 and 580 of the present invention are not necessarily implemented in the message center 440, but need only be implemented such that they are capable of operating in cooperation with the message center 440.

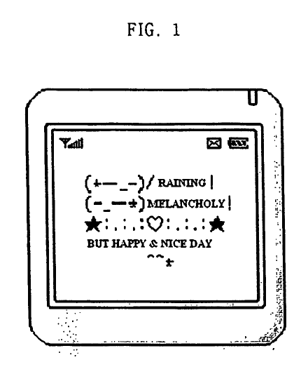

FIG. 6 is a view showing a multimedia message service according to an embodiment of the present invention. If the user of the message service creates a text message “(*--_-)/It's raining! (next line) (-_--*) I am melancholy! (next line) ν:.:.: [symbol] .:.:ν (next line) but happy and nice dayˆˆ*”, and transmits the text message, the text message would be displayed on the recipient's terminal unit in the prior art, as shown in FIG. 1. However, according to an embodiment of the multimedia message service of the present invention, the text message is displayed together with the avatar of the message originator, as shown in FIG. 6.

The avatar of FIG. 6 is selected through an on-line or off-line method when the originator applies for the multimedia message service of the present invention or after the application. After the selection, when the originator creates and sends a text message, the text message is displayed on the recipient's terminal unit as an image, in which the avatar of the originator is combined with the text message, as shown in FIG. 6.

As a preferred embodiment of the present invention, when the originator registers a plurality of avatars thereof, the originator can select a specific avatar using a predetermined method, for example, by marking an avatar identifier on a portion of a text message, when creating the text message. For example, if the originator registers two avatars and designates the avatars as “avatar_happy” and “avatar_sad”, respectively, any one avatar can be selected by marking “$$avatar_sad$$” on the last portion of the text message.

The system operation of displaying the screen of FIG. 6 on the recipient's terminal unit 460 is described with reference to FIG. 4. As described above, when the user of the multimedia message service of the present invention transmits the text message 430 using the originator's terminal unit 410 or 420, the message center 440 receives the text message 430. Preferably, the data received by the message center 440 are text-type data, which include the identifiers of both the originator and the recipient for the object of the message service in addition to the contents of the above-described text message 430. However, according to the implementation of the data, data other than text-type data, for example, binary-coded data, etc., may be included in the above-described data.

The message center 440 determines whether the originator of the text message 430 is the current user of the multimedia message service of the present invention on the basis of the originator's identifier. If the originator is not the user of the multimedia message service, the message center 440 transmits the text message 430 to the recipient's terminal unit 460 without change as in the prior art and terminates the service. However, if the determination of whether the originator is the user of the multimedia message service can be easily carried out, either through the identification number itself of the message service, for example, 700-xxxx, or the subscriber authentication of a specific Internet Web site, even though the determination is not performed on the basis of the originator's identifier, the determination procedure can be deleted.

If it is determined that the originator is the user of the multimedia message service, the message center 440 obtains the profile information of the recipient's terminal unit 460 in cooperation with the terminal information database unit 480 on the basis of the recipient's identifier. As described above, in an environment where all terminal units have the same profile in the multimedia message service of the present invention, this procedure may be deleted.

If it is determined that the recipient's terminal unit 460 has the capability of displaying the multimedia message 470 of the present invention on the basis of the profile information, the message center 440 obtains the avatar of the originator in cooperation with the multimedia library unit 450, and creates the multimedia message 470 of the present invention by combining the text data of the text message 430 with the avatar image of the originator. The multimedia message 470 may be combined with additional multimedia resources, such as sounds, in addition to the text data and avatar image. As a preferred embodiment of the combination, in the case of a video image part, the text and the avatar image are combined with each other, so that a single image, for example, a Joint Photographic Expert Group (JPEG) file or an image file having a unique format is provided.

If the originator has no registered avatar or if the obtainment of the avatar fails due to any problem during the process of obtaining the avatar of the originator by the message center 440 in cooperation with the multimedia library unit 450, the multimedia message 470 can be created using a basic avatar according to the specific implementation, or the text message 430 can be transmitted to the recipient's terminal unit 460 without change, as in the prior art. Further, if it is determined that the recipient's terminal unit 460 does not have the capability of displaying the multimedia message 470 of the present invention during the process of obtaining the profile information of the originator by the message center 440 in cooperation with the terminal information database unit 480, the message center 440 preferably transmits the text message 430 to the recipient's terminal unit 460 without change, as described above. Further, even if the obtainment of the profile information fails in the above process, the text message is preferably transmitted to the recipient's terminal unit 460 without change.

Then, the message center determines whether the recipient's terminal unit 460 is capable of receiving and processing the multimedia message 470 in a message format on the basis of the profile information of the recipient's terminal unit 460. If it is determined that the recipient's terminal unit 460 is capable of receiving and processing the multimedia message 470, the message center 440 transmits the multimedia message 470 to the recipient's terminal unit 460 as shown in FIG. 4, but if it is determined that the recipient's terminal unit 460 is incapable of receiving and processing the multimedia message 470 in a message format, the message center 440 places the multimedia message 470 at a predetermined location and transmits the access information to the location, for example, a callback URL thereof, to the recipient's terminal unit 460 as a text message, as shown in FIG. 5.

FIG. 7 is a view showing a multimedia message service according to another embodiment of the present invention. In the embodiment of FIG. 7, an originator creates and transmits a text message “Shall I get you some cookies and seasoned bar rice cake on my way back from the office? Let's love each other.”. A message center converts the text message into a multimedia message to provide the multimedia message service of the present invention, as shown in FIG. 7. In the embodiment of FIG. 7, some words of the text message are converted into suitable image icons. Such image icons are basically provided by the system, but the originator may additionally register new icons, or replace and delete existing icons.

The system operation for displaying the screen of FIG. 7 on the recipient's terminal unit 460 is almost similar to that of the embodiment of FIG. 6, so that a repeated description is not necessary. However, for the embodiment of FIG. 7, the substitution rules of image icons to be substituted by the message center 440 for respective words of the text message 430 are set in the multimedia library unit 450. Referring to FIG. 7, it can be seen that the substitution rules for the words “cookies”, “seasoned bar rice cake”, and “love”, are set in the multimedia library unit 450.

The multimedia library units 450 and 550 and multimedia sub-components thereof that have been schematically described above with reference to FIGS. 4 and 5 are described in detail. As described above, the multimedia library unit 450 or 550 is constructed in the form of sub-components, which means that the message center 440 or 450 can combine a plurality of multimedia sub-components provided in this way with each other to create a single multimedia object, that is, the multimedia message 470 or 570.

As described above, the multimedia library unit 450 or 550 may include various types of reference data. In order to obtain the multimedia message shown in FIG. 6, the avatar images of service users, or sub-components required to construct the avatars, and the combination rules of the avatars of users must be included as multimedia sub-components. In order to obtain the multimedia message shown in FIG. 7, image icons to be substituted for respective words, such as cookies, seasoned bar rice cake, and love, must be included as the multimedia sub-components.

Further, in order to combine the text data included in the text message 430 or 530 with other multimedia sub-components and create the single multimedia message 470 or 570, multimedia sub-components required to convert text into images are preferably included in the multimedia library unit.

The multimedia sub-component data included in the multimedia library unit 450 or 550 can be classified into data integrally provided by the provider of the multimedia message service according to the present invention, other service providers related to the service, etc., and data individually provided by service users. Further, the multimedia sub-component data can be classified into data to which substitution rules, generally set by the message center 440 or 540, are applied, and data to which substitution rules separately set by specific service users are applied.

On the basis of the above-description, the user of the multimedia message service of the present invention can influence the contents of the multimedia library unit 450 or 550 using a method, for example, the Internet. That is, the manipulations of adding a new multimedia sub-component to the multimedia library unit 450 or 550, changing existing sub-components to new components or deleting sub-components are possible.

The multimedia message 470 or 570 proposed in the present invention is not limited to a still image, but may include a moving picture and does not exclude a message able to interact with the user of the terminal unit. Further, as described above, the multimedia message 470 or 570 should be interpreted as a concept including audio components, for example, sound effects or ringer tones of the originator's terminal unit, in addition to video. That is, the multimedia message 470 or 570 of the present invention should be broadly interpreted as a multimedia message in the literal sense of the word.

As described above, the message center 440 or 540 of the present invention combines the multimedia sub-components with each other to create the multimedia message 470 or 570 on the basis of the text message 430 or 530 transmitted from the originator's terminal unit. The multimedia message combined in this way is basically comprised of a video component and an audio component. According to the multimedia message service of the present invention, the recipient provided with the multimedia message suitably manipulates the terminal unit, thus downloading an entire multimedia message or components thereof and utilizing the message or components as he or she desires.

For example, when receiving the multimedia message of FIG. 6, the recipient manipulates the terminal unit to download the avatar image, which is the video component, and to use the avatar image as he or she desires. Further, if the multimedia message includes sound, the recipient manipulates the terminal unit to download the sound, which is the audio component, and to use the sound as a ringer tone or music melody.

Further, if the multimedia message includes sounds or images, the sounds can be used as a kind of background music and the images can be used as a kind of background image when the recipient confirms the multimedia message 470 or 570. For this operation, when the recipient's terminal unit 460 or 560 parses the multimedia message, tags should be defined and attached to respective components so that a text message is displayed on the display screen, the audio component is replayed as background music and the image component is displayed as a background image.

FIG. 8 is a view showing a combination-type short message service according to an embodiment of the present invention. The present embodiment shows a case where emoticon data, advertisement data (including advertisement coupons), business card data, etc. are included as components constituting a library unit 850. Background music data or background image data have been described above, so that a detailed description thereof is not required. Emoticon, advertisement, or business card data can be simply constructed in the form of simple text. Such data can be preset by the user through the Internet, Wireless Application Protocol (WAP), etc., or set by the provider of the present service to correspond to his or her object.

For example, business card or emoticon data are preferably preset by the user of an originator's terminal unit 810 or 820. According to a setting type, the business card or emoticon data can be fixed data or suitably changed depending on the user's schedule, the recipient or the user's selection. On the contrary, advertisement data are more generally preset by the provider of the present combination-type short message service. That is, when an advertisement order is received, the transmission schedule of an advertisement message can be set as, for example, “1000 times per day” according to an order condition. Further, according to an order option, transmission conditions for an advertisement message can be selectively set as, for example, “20 to 25 year-old working men”. Of course, it is not impossible to implement advertisement data so that they are selected by the user of the originator's terminal unit 810 or 820.

In the meantime, in the case of advertisement data, it is preferable to obtain the permission of an originator or recipient, or both. For this operation, an advantage of providing the short message service at low cost or free can be assigned to users permitting the advertisement data. In contrast, the provider of the message service can obtain service charges from the amount of received orders. In order to maximize profits, the provider of the message service needs to set a transmission schedule and conditions for advertisement messages, and differentially set the transmission schedule and conditions according to the amount of received orders at the time of receiving advertisement orders.

FIG. 8 illustrates a case where a message center 840 transmits a text/MM message 870 to a recipient's terminal unit 860, but this case is only an embodiment of the present invention as described above with reference to FIG. 4. As shown in FIG. 5, it is also possible to provide one kind of access information, such as a callback URL, and allow the recipient's terminal unit 860 to access the callback URL. However, in the case of a message composed only of characters, the message center 840 preferably and directly transmits message data, as shown in FIG. 8.

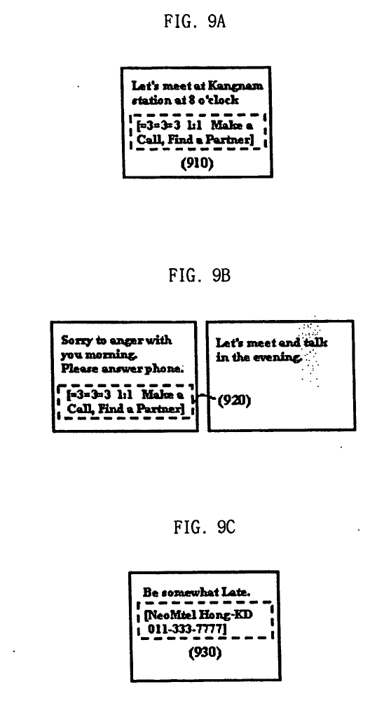

FIG. 9 is a view showing combination-type short messages according to three embodiments of the present invention. In the embodiment of FIG. 9A, a specific advertisement message 910 is combined with a text message “Let's meet at Kangnam station at 8 o'clock” transmitted by an originator. In the embodiment of FIG. 9C, a business card message 930 is combined with a text message “Be somewhat late” transmitted by an originator. In the meantime, if the size of a combination-type text message, in which the message transmitted by the originator is combined with an advertisement message or business card message, exceeds a threshold defined in SMS standards, for example, 80 bytes, it is preferable to divide the combination-type text message into a plurality of text messages each having a threshold size or less, and continuously transmit the plurality of text messages as short messages. This preferred embodiment is shown in FIG. 9B.

In current SMS standards, a limitation of 80 bytes exists for the size of one short message. Therefore, if the size of a text message 920 to be combined is SIZE_{—}1, “80-SIZE_{—}1” is the limitation of a user message. Therefore, the message transmitted by the user is divided into a plurality of sub-text messages each having a size of “80-SIZE_{—}1” or less. Thereafter, the text message 920 is combined with one or more sub-text messages, and the combined results are continuously transmitted to the recipient's terminal unit 860 as a plurality of short messages.

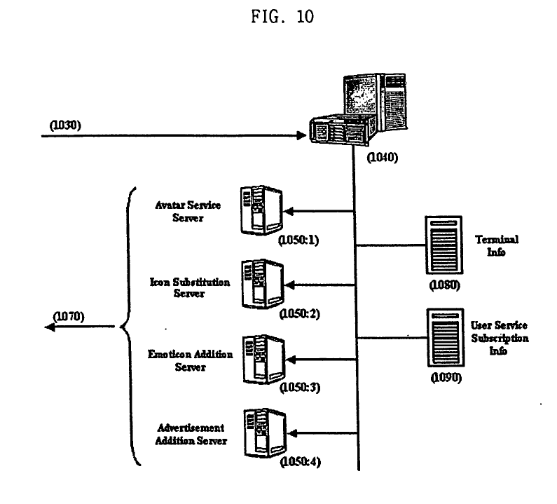

FIG. 10 is a view showing a server system 1040 for providing a multimedia message service and a combination-type short message service according to an embodiment of the present invention. If a text message 1030 is received from an originator's terminal, the server system 1040 of the present invention preferably inquires of a user service subscription information server 1090 about whether an originator subscribes to the multimedia message service or combination-type short message service of the present invention. If the originator subscribes to the message service, the server system 1040 creates a multimedia message or combination-type short message 1070 with the aid of corresponding servers 1050:1 to 1050:4, and transmits the multimedia message or combination-type short message 1070 to a recipient's terminal.

As described above, a terminal unit information server 1080 includes various types of pieces of specification information about the recipient's terminal to obtain information related to whether to directly receive a multimedia message or related to display specifications (monochrome/chromatic display, resolution, etc.), thus reflecting the information in the creation of a multimedia message.

In the meantime, in the present invention, it is more preferable that the originator designates service types to be applied to the text message 1030. This designation is especially required when the originator subscribes to various types of services, and also required because the originator may not always want to use the multimedia message service or combination-type short message service of the present invention even though the originator subscribes to one service. One of methods applied for this operation is to allow the originator to insert a specific identification symbol in the phone number of a recipient or message contents. For example, if a part “--number” or “#number” is inserted in the end of the recipient's phone number or message contents, the method can be set to provide services distinguished according to the “number”.

In this case, the server system 1040 determines whether the identification symbol is included in the text message 1030. If the identification symbol is not included in the text message 1030, the server system 1040 provides the conventional short message service, while if the identification symbol is included in the text message 1030, the sever system 1040 provides the multimedia message service or combination-type short message service of the present invention in cooperation with corresponding servers 1050:1 to 1050:4 according to the identification symbol.

### INDUSTRIAL APPLICABILITY

According to a method of providing multimedia messages of the present invention, there is an advantage in that a text-type message created and transmitted by a service user is combined with prepared multimedia data to create a new multimedia message and provide the multimedia message to a recipient's terminal unit, thus enabling various presentations to be implemented in a message service.

Further, according to the multimedia message provision method of the present invention, there is an advantage in that a recipient can download an entire multimedia message received or partial components thereof, and utilize the downloaded results as he or she desires, thus creating various business models.

1. A method for providing multimedia messages between an originating terminal unit and a receiving terminal unit, comprising:
receiving transmission data including a text message from the originating terminal unit;
obtaining an identifier of the originating terminal unit—hereinafter referred to as an “originating terminal identifier”—on the basis of the transmission data, searching an information database using the originating terminal identifier to obtain an avatar image of an originator, and creating a multimedia message, in which the avatar image and the text message are displayed as a single image, by combing an image of the text message with the avatar image;
obtaining an identifier of the receiving terminal unit—hereinafter referred to as a “receiving terminal identifier”—on the basis of the transmission data, searching the information database using the receiving terminal identifier to obtain profile information about the receiving terminal unit, and determining whether the receiving terminal unit has capability of receiving, processing and displaying the multimedia message in a message format on the basis of the profile information;
(1) if it is determined that the receiving terminal unit has the capability, transmitting the multimedia message to the receiving terminal unit in a message format; (2) while if it is determined that the receiving terminal unit does not have the capability, placing the multimedia message at a specific location on a mobile communication network, reconstructing the text message to allow access information to the location to be included in the text message, and transmitting the reconstructed text message to the receiving terminal unit, thus providing the multimedia message to browsing means of the receiving terminal unit when the browsing means attempts to access the location.

2. The multimedia message provision method according to claim 1, further comprising downloading the avatar image to the receiving terminal unit in response to a request from the receiving terminal unit.

3. A computer-readable recording medium for storing a program for implementing the multimedia message provision method of claim 1.

4. A computer-readable recording medium for storing a program for implementing the multimedia message provision method of claim 2.
